(19) United States
(12) Patent Application Publication
(10) Pub. No.: US 2011/0187078 A1
(43) Pub. Date: Aug. 4, 2011

(54) REAR SUSPENSION UNIT FOR AFTER MARKET USE IN FOLDING BIKES

(76) Inventor: MARK ANTONY HIGGON, HAMPSHIRE (GB)

(21) Appl. No.: 12/940,318

(22) Filed: Nov. 5, 2010

Related U.S. Application Data
(60) Provisional application No. 61/259,117, filed on Feb. 2, 2010.

(51) Int. Cl. B62K 25/04; B62K 19/30; B62K 19/38

(52) U.S. Cl. 280/284

(57) ABSTRACT

A Rear Wheel Suspension Unit for a folding bike comprising a Rear wheel mounting member pivotally connected to a chassis member and a seat tube/bottom bracket member, through the upper and lower linkage thereby forming a pivoting linkage system and a shock absorber is fitted to upper linkage and the lower fixed bracket to form a fully working rear suspension unit. Further, the unit is designed to be sold as an after market rear suspension for a Folding bike and which can be fitted at the time of purchase or at any time after the purchase.

### FIELD OF THE INVENTION

The present invention relates generally to the field of vehicle suspension systems, and more particularly, to a rear wheel suspension assembly for aftermarket use in folding bikes.

### BACKGROUND OF THE INVENTION

While riding a bike for fun and sports is very popular nowadays, the design of the bike is even more diversified and such design is and should be compact and portable oriented since the bike gives excellent mobility.

Folding bicycles have been around since the early seventies when innovative engineers came up with the idea of creating a bike that could be hung on a coat stand when not in use. Early models were heavy and clunky so were slow to catch on with the general public. However folding bikes of today are light, nimble and offer numerous advantages over conventional bicycles.

Folding bikes offer flexibility and ease of commuting via train/bus and bike as they can be carried free on public transport. Further they are virtually thief-proof, a huge advantage in major cities where bike theft is commonplace. They also fit effortlessly into cramped spaces so are ideal for apartment owners. When used as a commuter bike, they offer a healthy, green method of transport and potential cost savings versus a car when used with public transport for longer journeys. Folding bikes are also great as training bikes for cyclists travelling abroad and are super easy to pack as they simply fold into a travel bag.

A good and compact rear suspension system in a folding bike is essential for a comfortable ride when the folding bike is being used for commutation on a daily basis and also for avid travelers. Rear suspension systems are commonly used on bicycles, and are especially common on mountain bikes.

The rear suspension system helps to reduce the impact felt by the rider resulting from forces exerted on a rear wheel when traveling over rough terrain. When impact forces act on the rear wheel, the rear suspension system allows the rear wheel to be displaced relative to the bicycle frame, which, in turn, acts to absorb the impact.

The conventional bicycle rear suspension designs essentially comprise a main pivot located on a main frame of the bicycle for pivotally connecting thereto a swingarm or a rear frame portion. According to this type of rear suspension, the rear wheel pivotally moves in a circular path of constant radius about a single axis of rotation which is fixed relative to the main frame of the bicycle.

In some other systems, the rear suspensions are provided with more sophisticated linkage systems comprising upper and lower links adapted to pivotally connect the swingarm to the front frame portion of the bicycle such as to allow the rear wheel to travel in a different arc than with a single link system.

The conventional rear suspension designs include multiple lever members and, therefore, multiple pivots, typically exhibit better isolation of pedaling forces and braking forces from the rear suspension. Typically, a multiple lever rear suspension assembly will have a pair of lower arms i.e., chain stays, pivotally connected to the bicycle frame at a forward end and a link member pivotally mounted to the main frame at a location above the chain stays. A pair of rearward arms i.e., seat stays, are pivotally connected between rearward ends of the chain stays and link member. The rear wheel may be carried by either of the chain stays or seat stays. Typically, the rear shock absorber is operably positioned between the link member and the main frame. As a result, placement of the shock absorber is at a relatively high position with in the bicycle frame, thereby raising the overall center of gravity of the bicycle, which is detrimental to the handling qualities of the bicycle. This drawback is magnified in large suspension travel designs, wherein the size of the rear shock absorber is typically increased.

Further for bicycles such as folding bikes, intended to be ridden in different situations it would be advantageous to have an easily usable rear suspension allowing selectable amounts of wheel travel according to the intended use. Normally the aftermarket fastening of a rear suspension system to a normal bike is a relatively slow and cumbersome procedure typically involving removal, with use of a tool, of a fastener from a hole in a row of holes and refitting of the fastener in a different hole in the row.

Again many rear suspension systems available on the market allow the rear wheel of the bicycle to travel in a particular path that is dictated by the physical construction of the suspension system. Essentially, the rear wheel path is permanently fixed by the rear suspension design. Different rear wheel paths cause different reactions in the way the bicycle handles. Therefore, one rear wheel path that is suitable to a particular rider or condition may be unsuitable for another rider or condition.

Again generally, rear suspensions for bicycles comprise shock absorber systems including various types of springs and shock absorber systems and devices, and a pivot system defining the path of the rear wheel upon impact thereof with an uneven ground surface.

The relevant prior art methods, which deal with rear suspension systems for bikes, are as follows:

U.S. Pat. No. 5,240,269 (A) claims a suspension device employed between the rear wheel and the frame of a mountain bike. A lever arm pivoted to the frame carries the rear wheel at one end and the suspension device at the other. The rear wheel portion of the lever arm is about four times as long as is the suspension device portion. The suspension device includes a hollow elongated elastomeric spring carrying an aluminum telescoping portion. The telescoping portion supports the elastomer while allowing reciprocating movement along a major axis, but not allowing any rotational movement around that same axis.

U.S. Pat. No. 4,789,174 (A) comprises suspension bicycle in which a rear suspension includes swing arms, control arms, and hub plates connected to the seat riser tube of the frame in a trapezoidal arrangement. The swing arms, control arms, and hub plates are configured to balance the forces applied to the rear wheel by the chain during pedaling so as to prevent energy absorbing movement of the rear suspension as the result of such pedaling. A shock absorber is also connected to the swing arms to absorb shocks during riding. The suspension of the present invention also is configured to provide improved traction during pedaling uphill or over uneven surfaces.

U.S. Pat. No. 6,206,397 (B1) provides a rear suspension system for a bicycle. The system directs the rear wheel along a predetermined, S-shaped path as the suspension is compressed. The path is configured to provide a chainstay lengthening effect only at those points where this is needed to counterbalance the pedal inputs of the rider; at those points in the wheel travel path where there is a chainstay lengthening effect, the chain tension which results from the pedal inputs exerts a downward force on the rear wheel, preventing unwanted compression of the suspension. The system employs a dual eccentric crank mechanism mounted adjacent the bottom bracket shell to provide the desired control characteristics.

U.S. Pat. No. 5,452,910 (A) details a suspension assembly that is formed of an essentially horizontal swing arm which is pivotally attached at one end to the underside of a bicycle frame by a pair of short links and which carries the rear wheel at an opposite end. The geometry of the suspension assembly is designed to produce a substantially straight line trajectory of the rear wheel in an upward and rearward direction at an angle that is preferably 20 DEG-30 DEG with respect to a vertical line through the wheel axis of rotation to increase traction, making the acceleration forces apply an upward vertical force component to the frame, and a downward component to the frame under braking, independent of wheel position, that reduces rear frame lift (pitch). Furthermore, to obtain a constant pedal “feel,” the suspension geometry is also designed so that the maximum vertical height movement of the pedal crank axis of rotation can be kept to less than 5% of the vertical wheel travel (e.g., a 0.25″ crank axis height increase for a 4″ vertical wheel travel). The suspension is designed to attach to a standard frame leaving room for mounting of the derailleur between the frame and the rear wheel. In a particularly preferred form, the swing arm assembly is provided with a tubular derailleur mount and an upper tube to which the rear wheel brake assembly can be mounted.

U.S. Pat. No. 6,203,042 (B1) discloses a bicycle rear suspension system providing rearward relative motion of the rear axle includes a chain stay, seat stay, chain stay link, seat stay link and shock absorber, with those components being assembled to a main front frame. The frame includes a head tube for supporting a front steering fork, a seat tube for supporting a seat, and a bottom bracket for supporting a pedal crank and chain drive mechanism, the seat tube and bottom bracket being supported so that there is a vertical space between them. The components of the rear suspension system are assembled to the frame within the space between the seat tube and bottom bracket. The chain stay link is pivotally attached to the frame so that, upon upward movement of the chain stay, the chain stay link pivots to cause the chain stay and thus the rear axle supported thereon to move slightly rearwardly relative to the frame.

UK Patent Publication No: GB2454021 discloses a bicycle with a rear suspension system consisting of a link member, which connects pivotally at a lower end of the bicycle main frame, above and forward of the bottom bracket on link support plates. A shock absorber is connected at a forward end on a down tube of the main frame, and slopes downwards and rearwards to connect to an upper pivot of the link member on a second axis. Chain stay members connect pivotally to a lower pivot point of the link member and extend in a rearward direction and connect with a mount for receiving a rear wheel and hence, via the mount and above the wheel axis, pivotally connecting to seat stay members. The members are pivotally connected at an upper pivot point to a seat tube of the main frame. The shock absorber extends between the link support plates.

UK Patent Publication No: GB2417468 claims a Bicycle rear suspension comprising of a frame, a rear wheel and a rear suspension which comprises a swing arm carrying the wheel and two pivot links pivotably connected at respective pivot points with the frame and at respective pivot points with the arm so as to form, together with parts of the frame and arm, a four-bar linkage.

UK Patent Publication No: GB2360497 describes a Bicycle frame and rear suspension assembly consisting of a frame, a rear wheel swing arm pivotably mounted on the frame and a spring and damper unit acting between the frame and the arm. The unit is connected with the arm at a selectable one of a plurality of different positions each allowing a respective one of a plurality of different amounts of pivot movement of the arm relative to the travel for the same spring or damping stroke of the unit.

UK Patent Publication No: GB2378161 claims a folding structure for a bicycle that has seat strut has a pair of lugs at its rear end that are connected to a shock absorber. The connection is releasable due to arcuate recesses in the lugs that locate a releasable fastening with the upper end of the shock absorber. The other end of the shock absorber is connected to a chain stay via holes.

However the purpose and methodology of all the inventions that are part of prior art do not envisage the unique embodiment of the rear suspension unit for a folding bicycle. The rear suspension systems above are not specialized in working with folding bikes.

Accordingly, a need exists for a rear suspension design especially well suited for use in folding bikes and to overcome the above-mentioned problems associated with a folding bicycle's effective usage. The present invention differs from the existent prior art in that it seeks to provide a rear suspension unit as a complete after market product designed to be used with the folding bikes.

Further it will be apparent to those skilled in the art that the objects of this invention have been achieved by providing an after market rear suspension unit for a folding bike which is unique in nature unlike existing suspension systems for use in normal bikes and that are suited only for limited purposes. Various changes may be made in and without departing from the concept of the invention. Further, features of some stages disclosed in this application may be employed with features of other stages. Therefore, the scope of the invention is to be determined by the terminology of the following description and the legal equivalents thereof.

### SUMMARY OF THE INVENTION

This present invention may be summarized, at least in part, with reference to its objects.

It is therefore a primary objective of the present invention to provide a complete after market rear suspension unit for a folding bike with a quality comfortable superior ride.

Another object of this invention is to provide a rear suspension unit which can be fitted at the time of purchase of a folding bike or at any time after purchase.

Another object of this invention is to provide a rear suspension unit which has a simple structure.

Another object of this invention is to provide a rear suspension unit which will have fixings to allow V type brakes and/or Disc type brakes.

Another object of this invention is to provide a rear suspension unit that is easily fittable with the folding bike.

Another object of this invention is to provide a rear suspension unit that is easily integrable with the folding bike.

Yet another object of this invention is to provide a rear suspension unit that is adaptable to be used in a variety of bicycle frames including molded fiber reinforced plastic frame or a metal frame, such as the welded and heat treated aluminum type of frame or metal frame made of steel, aluminum or titanium, or a combination of materials.

The above summary is intended to illustrate exemplary embodiments of the invention, which will be best understood in conjunction with the detailed description to follow, and are not intended to limit the scope of the invention. Additional objects and embodiments of the invention will be set forth in part in the description which follows, and in part will become apparent to those skilled in the art upon examination of the following, or may be learned by practice of the invention. These and other objects and advantages and features of the present invention will be more readily apparent when considered in reference to the following description and when taken in conjunction with the accompanying drawings listed below.

### DESCRIPTION OF DRAWINGS

FIG. 1 is a schematic diagram of the preferred embodiment of the Rear Suspension Unit and demonstrates the suspension system for a Folding bicycle comprising a rear wheel mounting member (dropout) 1, a chassis member 2, an upper linkage 3, a seat tube/bottom bracket member 5, a lower linkage 6, lower fixed bracket 8, a downtube member 9, a strengthening bar 10 and a strengthening bar 11.

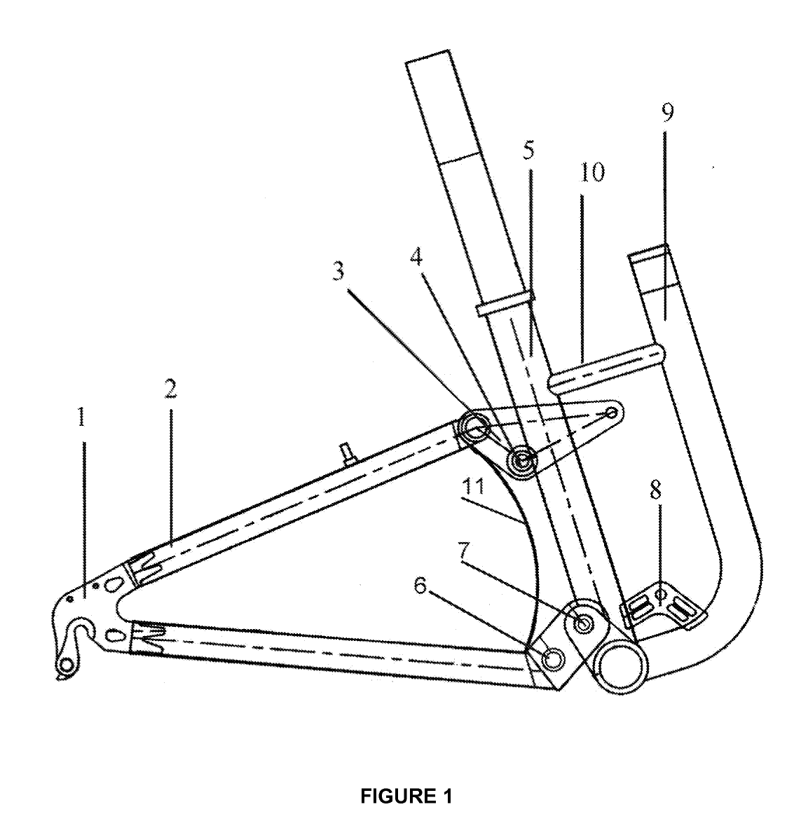

### DETAILED DESCRIPTION OF THE INVENTION

The following description is presented to enable any person skilled in the art to make and use the invention, and is provided in the context of particular applications of the invention and their requirements. The present invention can be configured as follows:

The present invention comprising of an aftermarket rear suspension unit is designed for use in folding bikes.

According to an embodiment, the rear wheel mounting member (dropout) 1 is fixed to the chassis member 2. An upper linkage 3 is pivotally connected 4 to the chassis member 2 and seat tube/bottom bracket member 5. A lower linkage 6 is pivotally connected 7 to the chassis member 2 and downtube/bottom bracket member 5. This entire structure constitutes an effective pivoting linkage system.

According to another embodiment of this invention, the lower bracket 8 is fixed to seat tube/bottom bracket member 5 and downtube member 9.

According to another embodiment of this invention, a strengthening bar 10 is fixed to seat tube/bottom bracket 5 and downtube member 9.

According to another embodiment of this invention, a strengthening bar 11 is fixed to the wide V of chassis member 2.

According to a further embodiment of this invention, a shock absorber is fitted to upper linkage 3 and the lower fixed bracket 8.

In another embodiment of this invention, the rear suspension unit in designed in such a way that it will have fixing to allow V type brakes and or Disc type brakes.

The present rear suspension unit thus consists a pivoting linkage system formed through the rear wheel mounting member pivotally connecting to a chassis member through the upper and lower linkage. To fix the present rear suspension unit onto the folding bike, the front part of the folding bike is fixed onto the rear suspension unit. Through the above pivoting linkage system the folding bike then pivots and locks onto the suspension unit using the original design of the folding bike.

The above pivoting linkage system thus works to form a fully working rear suspension unit for a folding bike.

Further, the rear suspension is aligned within a natural niche in the folding bike such that even if the bike is adjusted to fold, the rear suspension does not protrude outward or create a cumbersome structure, but fits compactly into the space in the bike frame. The invention thus does not increase the size after folding and improves the smoothness in riding.

The present invention is designed to be a complete after market rear suspension unit for a folding bike. The unit can be fitted to any folding bike which does not have rear suspension at the time of purchase or at any time after the purchase. The complete after market rear suspension for a folding bike has been designed to give a quality comfortable superior ride than one gets with the ordinary non-suspension version of any folding bike.

In a typical configuration, the rear suspension unit of the present invention can provide varying degrees of spring rate in the folding bike as may be desirable for normal riding of the folding bicycle on the road, an off-road climb which requires more compliant springing with greater suspension travel to cope with the rougher terrain and a rough descent which requires long travel suspension. Consequently, the benefits of the rear wheel suspension unit in the folding bike can be optimised for the different riding conditions encountered by the user of the folding bike so that the user is not discouraged by the prospect of inconvenience and delay.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the claims to be filed.

It will be apparent to those skilled in the art that the objects of this invention have been achieved by providing the above invention. However various changes may be made in the structure of the invention without departing from the concept of the invention. Therefore, the scope of the invention is to be determined by the terminology of the claims to be filed and the legal equivalents thereof.

I claim:

1. A rear suspension unit for after market use in folding bikes comprising of a rear wheel mounting member (dropout) 1, a chassis member 2, an upper linkage 3, a seat tube/bottom bracket member 5, a lower linkage 6, lower fixed bracket 8, a downtube member 9, a strengthening bar 10 and a strengthening bar 11 characterized in that said rear wheel mounting member (dropout) 1 is fixed to said chassis member 2.

2. The rear suspension unit as claimed in claim 1 wherein said upper linkage 3 is pivotally connected 4 to said chassis member 2 and said seat tube/bottom bracket member 5.

3. The rear suspension unit as claimed in claim 1 wherein said lower linkage 6 is pivotally connected 7 to said chassis member 2 and said downtube/bottom bracket member 5.

4. The rear suspension unit as claimed in claim 1 wherein said lower bracket 8 is fixed to said seat tube/bottom bracket member 5 and said downtube member 9.

5. The rear suspension unit as claimed in claim 1 wherein said strengthening bar 10 is fixed to said seat tube/bottom bracket 5 and said downtube member 9.

6. The rear suspension unit as claimed in claim 1 wherein said strengthening bar 11 is fixed to wide V of said chassis member 2.

7. The rear suspension unit as claimed in claim 1 wherein a shock absorber is fitted to said upper linkage 3 and said lower fixed bracket 8.

8. The rear suspension unit as claimed in claim 1 wherein the front part of said folding bike is fixed onto said rear suspension unit.

9. The rear suspension unit as claimed in claim 1 wherein said folding bike pivots and locks onto said suspension unit using the pivoting linkage system formed through said rear wheel mounting member pivotally connecting to a chassis member through said upper and lower linkage.

10. The rear suspension unit as claimed in claim 1 wherein said unit is aligned within a natural niche in said folding bike without any outward protrusions and with a compact fit into the space in said bike frame.

11. The rear suspension unit as claimed in claim 1 wherein said unit can be used for V type brakes and or Disc type brakes.
